(19) United States
(12) Patent Application Publication
(10) Pub. No.: US 2026/0308425 A1
(43) Pub. Date: Oct. 8, 2026

(54) TERTIARY AMINES FOR IMPROVING THE CREEP BEHAVIOR OF CHEMICAL ANCHORS

(71) Applicant: Hilti Aktiengesellschaft, Schaan (LI)

(72) Inventors: Ana-Maria Martin-Lasanta, Giessen (DE); Nicole Behrens, Muenchen (DE)

(73) Assignee: Hilti Aktiengesellschaft, Schaan (LI)

(21) Appl. No.: 18/996,518

(22) PCT Filed: Jul. 6, 2023
(86) PCT No.: PCT/EP2023/068700

§ 371 Date: Jan. 17, 2025

(30) Foreign Application Priority Data
Jul. 20, 2022 (EP) 22186012.5

(51) Int. Cl. C09J 11/06; C09J 11/04; C09J 163/04

(52) U.S. Cl. CPC C09J 11/06; C09J 11/04; C09J 163/04

(57) ABSTRACT

At least one tertiary amine in an epoxy resin composition improves the creep behavior of a chemical anchor manufactured from the epoxy resin composition. The at least one tertiary amine is present in the epoxy resin composition in a weight percentage of ≥1.0 wt %, based on a total weight of the epoxy resin composition.

The invention relates to the use of tertiary amines in an epoxy resin composition for improving the creep behavior of a chemical anchor manufactured from the epoxy resin composition.

Multi-component compositions based on curable epoxy resins and amines have been known for some time and are used as chemical anchors for fastening construction elements such as anchor rods, reinforcing bars, and screws in boreholes of various substrates, such as concrete, for example.

Chemical anchors tend to creep during the service life of a chemical anchor, in particular under continuous load and at elevated temperatures. In this case, creep describes the plastic deformation or movement of a chemical anchor as a result of the impact of sustained loading. Creep significantly impairs the performance of a chemical anchor, as described, for example, in R. Nilforoush; M. Nils; G. Söderlind; L. Elfgren; “Long-Term Performance of Adhesive Bonded Anchors”, Structural Journal, 2016, 113 (2), 251-261. The characterization of creep and the associated specification of the creep behavior of a chemical anchor play an important role in the durability and reliability of an anchoring point using a chemical anchor in the construction industry. The specifications regarding creep behavior are therefore used when designing an anchoring point in the construction industry.

EP 1 716 195 B1 describes the use of tertiary amines in chemical anchoring systems. A relationship between the use of tertiary amines in the curing agent component of a multicomponent composition and the increase in the maximum achievable glass transition temperature of the composition manufactured from the multicomponent composition is postulated. However, epoxy-amine systems do not fully cure at temperatures below their maximum possible glass transition temperature. This applies in particular to systems which cure in thin layers, for example in the annular gap between the concrete and anchor, which is about 1 mm and therefore cannot be heated exothermically. Investigations into this were carried out by, among others, Michel et al., Constr. Build. Mat., 2020, 231, 117206 and Kroutilova et al., J. Appl. Pol. Sci., 2006, 99, 3669. Since the maximum glass transition temperature of the system is not present in creep tests which are generally carried out below the maximum glass transition temperature of the system, no impact on the creep behavior of a chemical anchor can be derived from the specification of the final glass transition temperature. Therefore, no connection between the use of tertiary amines and an improved creep behavior of chemical anchors is known.

In view of the above embodiments, it is desirable to be able to provide chemical anchors, in particular epoxy amine-based chemical anchors, with improved creep behavior.

The object of the invention is therefore to provide a simple and cost-effective solution with which the creep behavior of chemical anchors, in particular of epoxy amine-based chemical anchors, can be improved. The object of the present invention is in particular to improve the creep behavior of epoxy amine-based chemical anchors at elevated temperatures, preferably between 40° C. and the glass transition temperature of the chemical anchor.

The underlying object of the invention is achieved by using at least one tertiary amine in an epoxy resin composition in a weight percentage of ≥1.0 wt. % based on the total weight of the epoxy resin composition according to claim 1. Preferred embodiments of the use according to the invention are provided in the dependent claims, which may optionally be combined with one another.

Within the context of the invention, the terms used above and in the following description have the following meanings:

“Creep behavior” describes the plastic deformation, displacement or movement of a chemical anchor as a result of the impact of sustained loading (continuous load).

“Amines” are compounds derived from ammonia through the replacement of one, two, or three hydrogen atoms by hydrocarbon groups and which have the general structures RNH₂ (primary amine), R₂NH (secondary amine) and R₃N (tertiary amine) (see: IUPAC Compendium of Chemical Terminology, 2nd ed. (the “Gold Book”), compiled by A. D. McNaught and A. Wilkinson, Blackwell Scientific Publications, Oxford (1997).

Surprisingly, it has now been found that the use of at least one tertiary amine in a weight percentage of ≥1.0 wt. %, based on the total weight of the epoxy resin composition, produces a significant improvement in the creep behavior of a chemical anchor manufactured from the epoxy resin composition.

The epoxy resin composition is preferably a multi-component epoxy resin composition, preferably a two-component epoxy resin composition, which comprises an epoxy resin component (A) and a curing agent component (B). The epoxy resin component (A) comprises at least one curable epoxy resin. The curing agent component (B) comprises at least one amine which is reactive to epoxy groups. In the multicomponent epoxy resin composition, the epoxy resin component (A) and the curing agent component (B) are separated from one another in a reaction-inhibiting manner.

To improve the creep behavior of a chemical anchor, it is material to the invention that ≥1.0 wt. % of at least one tertiary amine based on the total weight of the epoxy resin composition is used in the epoxy resin composition.

The tertiary amine is preferably used in the curing agent component (B) of a multicomponent epoxy resin composition. The curing agent component (B) preferably comprises ≥5.0 wt. %, preferably 5.0 to 20 wt. %, of the tertiary amine based on the total weight of the curing agent component (B). In a preferred embodiment of the Invention, the curing agent component (B) comprises 5.0 to 10.0 wt. % of the tertiary amine based on the total weight of the curing agent component (B).

The epoxy resin composition is used to manufacture chemical anchors which are usually used for construction purposes. The expression “for construction purposes” refers to the structural adhesion of concrete/concrete, steel/concrete, or steel/steel or one of said materials with other mineral materials, to the structural strengthening of components made of concrete, brickwork, and other mineral materials, to reinforcement applications with fiber-reinforced polymers of building objects, to the chemical fastening of surfaces made of concrete, steel, or other mineral materials, in particular the chemical fastening of construction elements and anchoring means, such as anchor rods, anchor bolts, (threaded) rods, (threaded) sleeves, reinforcing bars, screws, and the like, in boreholes in various substrates, such as (reinforced) concrete, brickwork, other mineral materials, metals (e.g. steel), ceramics, plastics, glass, and wood.

The tertiary amine used for the use according to the invention preferably comprises at least three tertiary amino groups. The tertiary amine used for the use according to the invention preferably comprises a 6-membered ring. In a preferred embodiment, the tertiary amine comprises at least three tertiary amino groups and a 6-membered ring, preferably a 6-membered aromatic ring.

In a preferred embodiment, the tertiary amine is selected from the group of the tertiary aminophenols, preferably from the group of 2,4,6-tris(di-C₁-C₆-alkylamino)phenols.

The tertiary amine is particularly preferably selected from the group consisting of 2,4,6-tris(dimethylaminomethyl)phenol (commercially available under the trade name Ancamine® K54) and 1,3,5-tris[3-(dimethylamino)propyl]hexahydro-1,3,5-triazine (commercially available under the trade name Lupragen® N600).

In a particularly preferred embodiment, 2,4,6-tris(dimethylaminomethyl)phenol is used for the use according to the invention to improve the creep behavior of a chemical anchor.

The curing agent component (B) comprises at least one amine which is reactive to epoxy groups. Corresponding amines are known to a person skilled in the art. Preferably, the at least one amine which is reactive to epoxy groups is selected from the group consisting of aliphatic, alicyclic, aromatic and araliphatic amines, and which has on average per molecule at least two reactive hydrogen atoms bonded to a nitrogen atom.

Examples of amines which are reactive to epoxy groups are specified below, without this in any way restricting the scope of the invention: 1,2-diaminoethane(ethylenediamine), 1,2-propanediamine, 1,3-propanediamine, 1,4-diaminobutane, 2,2-dimethyl-1,3-propanediamine (neopentanediamine), diethylaminopropylamine (DEAPA), 2-methyl-1,5-diaminopentane, 1,3-diaminopentane, 2,2,4- or 2,4,4-trimethyl-1,6-diaminohexane and mixtures thereof (TMD), 1,3-bis(aminomethyl)-cyclohexane, 1,2-bis(aminomethyl)cyclohexane, hexamethylenediamine (HMD), 1,2- and 1,4-diaminocyclohexane (1,2-DACH and 1,4-DACH), bis(4-amino-3-methylcyclohexyl)methane, diethylenetriamine (DETA), 4-azaheptane-1,7-diamine, 1,11-diamino-3,6,9-trioxundecane, 1,8-diamino-3,6-dioxaoctane, 1,5-diamino-methyl-3-azapentane, 1,10-diamino-4,7-dioxadecane, bis(3-aminopropyl)amine, 1,13-diamino-4,7,10-trioxatridecane, 4-aminomethyl-1,8-diaminooctane, 2-butyl-2-ethyl-1,5-diaminopentane, N,N-bis(3-aminopropyl)methylamine, triethylenetetramine (TETA), tetraethylenepentamine (TEPA), pentaethylenehexamine (PEHA), 1,3-benzenedimethanamine (m-xylylenediamine, MXDA), 1,4-benzenedimethanamine (p-xylylenediamine, PXDA), 5-(aminomethyl)bicyclo[[2.2.1]hept-2-yl]methylamine (NBDA, norbornane diamine), dimethyldipropylenetriamine, dimethylaminopropylaminopropylamine (DMAPAPA), 3-aminomethyl-3,5,5-trimethylcyclohexyl amine (isophorone diamine (IPDA)), diaminodicyclohexyl methane (PACM), diethylmethylbenzenediamine (DETDA), 4,4′-diaminodiphenylsulfone (dapsone), mixed polycyclic amines (MPCA) (e.g. Ancamine 2168), dimethyldiaminodicyclohexylmethane (Laromin C260), 2,2-bis(4-aminocyclohexyl) propane, (3(4),8(9)bis(aminomethyldicyclo[5.2.1.0^{2.6}]decane (mixture of isomers, tricyclic primary amines; TCD-diamine), methylcyclohexyl diamine (MCDA), N,N′-diaminopropyl-2-methylcyclohexane-1,3-diamine, N,N′-diaminopropyl-4-methylcyclohexane-1,3-diamine, N-(3-aminopropyl)cyclohexylamine, and 2-(2,2,6,6-tetramethylpiperidin-4-yl) propane-1,3-diamine.

Preferred amines are polyamines, such as 2-methylpentanediamine (DYTEK® A), 3-aminomethyl-3,5,5-trimethylcyclohexane (IPDA), 1,3-benzenedimethanamine (m-xylylenediamine, MXDA), 1,4-benzenedimethanamine (p-xylylenediamine, PXDA), 1,6-diamino-2,2,4-trimethylhexane (TMD), diethylenetriamine (DETA), triethylenetetramine (TETA), tetraethylenepentamine (TEPA), pentaethylenehexamine (PEHA), N-ethylaminopiperazine (N-EAP), (3(4),8(9)bis(aminomethyl)dicyclo[5.2.1.0^{2,6}]decane (mixture of isomers, tricyclic primary amines; TCD-diamine), 1,14-diamino-4,11-dioxatetradecane, dipropylenetriamine, 2-methyl-1,5-pentanediamine, N,N′-dicyclohexyl-1,6-hexanediamine, N,N′-dimethyl-1,3-diaminopropane, N,N′-diethyl-1,3-diaminopropane, N,N-dimethyl-1,3-diaminopropane, secondary polyoxypropylenedi- and triamines, 2,5-diamino-2,5-dimethylhexane, bis(amino-methyl)tricyclopentadiene, 1,8-diamino-p-menthane, bis(4-amino-3,5-dimethylcyclohexyl)methane, 1,3-bis(aminomethyl)cyclohexane (1,3-BAC), dipentylamine, N-2-(aminoethyl)piperazine (N-AEP), N-3-(aminopropyl)piperazine, piperazine, and methylcyclohexyl diamine (MCDA).

The amines can be used both individually and in a mixture of two or more of the specified amines.

The amine which is reactive to epoxy groups is preferably contained in the curing agent component (B) in a proportion of 10 to 90 wt. %, particularly preferably from 35 to 60 wt. %, based on the total weight of the curing agent component (B).

The curing agent component (B) preferably comprises a salt (S) selected from the group consisting of salts of nitric acid, salts of halogens, salts of trifluoromethanesulfonic acid, and combinations thereof. The following compounds in particular are suitable for use as the salt(S): Ca(NO₃)₂ (calcium nitrate, usually used as Ca(NO₃)₂ tetrahydrate), a mixture of Ca(NO₃)₂/HNO₃, KNO₃ (potassium nitrate), NaNO₃ (sodium nitrate), Mg(NO₃)₂ (magnesium nitrate, usually used as Mg(NO₃)₂ hexahydrate), Al(NO₃)₃ (aluminum nitrate, usually used as Al(NO₃)₃ nonahydrate), NH₄NO₃ (ammonium nitrate), Ca(NO₂)₂ (calcium nitrite), NaCl (sodium chloride), NaBr (sodium bromide), NaI (sodium iodide), Ca(CF₃SO₃)₂ (calcium triflate), Mg(CF₃SO₃)₂ (magnesium triflate), Li(CF₃SO₃)₂ (lithium triflate). The salts can be used both individually and in a mixture of two or more of the specified salts. The salt(S) is preferably contained in the curing agent component (B) in a proportion of 0.1 to 15 wt. %, preferably in a proportion of 1.0 to 10.0 wt. %, based on the total weight of the curing agent component (B).

In order to improve the solubility properties of the salt(S) in the curing agent component (B), the salt(S) can be dissolved in a suitable solvent and used accordingly as a solution. Organic solvents such as methanol, ethanol, and glycerol are suitable for this purpose.

The curing agent component (B) can comprises further additives from the group of solvents, further phenolic accelerators, co-accelerators, adhesion promoters, and inorganic fillers.

Non-reactive diluents (solvents) may preferably be contained in amount of up to 30 wt. %, based on the total weight of the curing agent component (B), for example from 1 to 20 wt. %. Examples of suitable solvents are alcohols, such as methanol, ethanol or glycols, lower alkyl ketones such as acetone, di-low-alkyl low-alkanoyl amides such as dimethylacetamide, low-alkyl benzenes such as xylenes or toluene, phthalic acid esters or paraffins. The amount of solvents is preferably <5 wt. %, based on the total weight of the curing agent component (B).

Phenolic accelerators are preferably selected from salicylic acid, styrenated phenols, and cardanol, and mixtures thereof. These may be present in the curing agent component (B) in a proportion of 0 to 10 wt. %, based on the total weight of the curing agent component.

Benzyl alcohol, novolac resins, imidazoles, organophosphines, toluenesulphonic acids, Lewis bases or acids such as phosphoric acid esters, or mixtures of two or more thereof, can be used as co-accelerators, for example. The co-accelerators are preferably contained in the curing agent component (B) in a weight proportion of 0.001 to 5 wt. %, based on the total weight of the curing agent component (B).

By using an adhesion promoter, the cross-linking of the borehole wall with the mortar mass is improved such that the adhesion increases in the hardened state. Suitable adhesion promoters are selected from the group of silanes that have at least one Si-bound hydrolyzable group, such as 3-glycidoxypropyltrimethoxysilane, 3-2-(3,4-epoxycyclohexyl)ethyltrimethoxysilane, N-2-glycidoxypropyltriethoxysilane, N-2-(aminoethyl)-3-aminopropyl-(aminoethyl)-3-aminopropylmethyl-diethoxysilane, triethoxysilane, 3-aminopropyl-trimethoxysilane, 3-aminopropyltriethoxysilane, N-phenyl-3-aminoethyl-3-aminopropyl-trimethoxysilane, 3-mercaptopropyltrimethoxysilane, and 3-mercaptopropylmethyldimethoxysilane. 3-aminopropyltrimethoxysilane (AMMO), 3-aminopropyltriethoxysilane (AMEO), 2-aminoethyl-3-aminopropyltrimethoxysilane (DAMO) and trimethoxysilylpropyldiethylenetetramine (TRIAMO) are particularly preferred as adhesion promoter. Further silanes are described, for example, in EP3000792 A1.

The adhesion promoter can be contained in an amount of up to 10 wt. %, preferably from 0.1 to 5 wt. %, more preferably from 1.0 to 2.5 wt. %, based on the total weight of the curing agent component (B).

Inorganic fillers, in particular cements such as Portland cement or aluminate cement and other hydraulically setting inorganic substances, quartz, glass, corundum, porcelain, earthenware, barite, light spar, gypsum, talc and/or chalk, and mixtures thereof are used as fillers. Thickeners such as fumed silica can also be used as inorganic filler. Further details of fillers which can be used are specified in WO2020/058015 A1, for example. The inorganic fillers can be added in the form of sands, powders, or molded bodies, preferably in the form of fibers or balls. The fillers may also be present in one or in all components of the multicomponent composition.

The proportion of fillers is preferably 0 to 75 wt. %, for example 10 to 75 wt. %, preferably 15 to 75 wt. % and more preferably 20 to 50 wt. %, even more preferably 25 to 40 wt. %, based on the total weight of the curing agent component (B).

The epoxy resin component (A) comprises at least one curable epoxy resin. As a curable epoxide in the epoxide resin component (A), a plurality of the compounds known to a person skilled in the art and commercially available for this purpose are considered which contain on average more than one epoxide group, preferably two epoxide groups, per molecule. These epoxy resins can be both saturated and unsaturated and aliphatic, alicyclic, aromatic, or heterocyclic and also have hydroxyl groups. They may furthermore contain substituents which do not cause any interfering side reactions under mixing or reaction conditions, for example alkyl or aryl substituents, ether groups and the like. Trimeric and tetrameric epoxides are also suitable within the scope of the invention.

The epoxy resins are preferably glycidyl ethers which are derived from polyhydric alcohols, in particular from polyhydric phenols such as bisphenols and novolacs, in particular those having an average glycidyl group functionality of 1.5 or greater, in particular 2 or greater, for example from 2 to 10.

The epoxy resins can have an epoxy equivalent weight (EEW) of 120 to 2,000 g/EQ, preferably 140 to 400, in particular 155 to 195, for example 165 to 185. It is also possible to use mixtures of a plurality of epoxy resins.

Examples of the polyhydric phenols used to prepare the epoxy resins are resorcinol, hydroquinone, 2,2-bis-(4-hydroxyphenyl) propane (bisphenol A), isomeric mixtures of dihydroxyphenylmethane (bisphenol F), tetrabromobisphenol A, novolacs, 4,4′-dihydroxyphenylcyclohexane, and 4,4′-dihydroxy-3,3′-dimethyldiphenylpropane. The epoxide resin is preferably a diglycidyl ether of bisphenol A or bisphenol F or a mixture thereof. Liquid diglycidyl ethers based on bisphenol A and/or F with an EEW of 180 to 190 g/EQ are particularly preferred.

Further examples are hexanediol diglycidyl ether, trimethylolpropane triglycidyl ether, bisphenol-A-epichlorohydrin resins and/or bisphenol-F-epichlorohydrin resins, for example having an average molecular weight of Mn<2000 g/mol.

The proportion of epoxide resin is >0 to 100 wt. %, preferably 10 to 70 wt. % and particularly preferably 30 to 60 wt. %, based on the total weight of the epoxy resin component (A).

In addition to the epoxy resins, the epoxy resin component (A) may optionally contain at least one reactive diluent. Glycidyl ethers of aliphatic, alicyclic, or aromatic monoalcohols or in particular polyalcohols having a lower viscosity than epoxies containing aromatic groups are used as reactive diluents. Examples of reactive diluents are monoglycidyl ethers, e.g. o-cresyl glycidyl ether, and glycidyl ethers having an epoxide functionality of at least 2, such as 1,4-butanediol diglycidyl ether (BDDGE), cyclohexanedimethanol diglycidyl ether and hexanediol diglycidyl ether, as well as tri- or higher glycidyl ethers, such as glycerol triglycidyl ether, pentaerythritol tetraglycidyl ether, trimethylolpropane triglycidyl ether (TMPTGE), or trimethylolethane triglycidyl ether (TMETGE), with trimethylolethane triglycidyl ether being preferred. Mixtures of two or more of these reactive diluents can also be used, preferably mixtures containing triglycidyl ethers, particularly preferably as a mixture of 1,4-butanediol diglycidyl ether (BDDGE) and trimethylolpropane triglycidyl ether (TMPTGE) or 1,4-butanediol diglycidyl ether (BDDGE) and trimethylolethane triglycidyl ether (TMETGE).

The reactive diluents are preferably present in an amount of from 0 to 60 wt. %, particularly from 1 to 20 wt. %, based on the total weight of the epoxy resin component (A).

Suitable epoxy resins and reactive diluents can also be found in the standard reference from Michael Dornbusch, Ulrich Christ and Rob Rasing, “Epoxidharze,” Vincentz Network GmbH & Co. KG (2015), ISBN 13:9783866308770. These compounds are included here by reference.

Furthermore, the epoxy resin component (A) can contain conventional additives, in particular adhesion promoters and fillers, as already described for the curing agent component (B).

The proportion of fillers is preferably 0 to 75 wt. %, for example 10 to 75 wt. %, preferably 15 to 75 wt. %, and more preferably 20 to 50 wt. %, even more preferably 25 to 40 wt. %, based on the total weight of the epoxy resin component (A).

Further conceivable additives to the multicomponent epoxide resin composition are also thixotropic agents such as optionally organically after-treated fumed silica, bentonites, alkyl- and methylcelluloses and castor oil derivatives, plasticizers such as phthalic or sebacic acid esters, stabilizers, antistatic agents, thickeners, flexibilizers, curing catalysts, rheology aids, wetting agents, coloring additives such as dyes or pigments, for example for different staining of components for improved control of their mixing, as well as wetting agents, desensitizing agents, dispersants and other control agents for the reaction rate, or mixtures of two or more thereof. The multicomponent epoxide resin composition is preferably present in cartridges or film pouches which comprise two or more separate chambers in which the epoxide resin component (A) and the curing agent component (B) of the mortar composition are arranged separately so as to inhibit a reaction.

For the use as intended, the epoxide resin component (A) and the curing agent component (B) are discharged out of the separate chambers and mixed in a suitable device, for example a static mixer or dissolver. The mixture of epoxy resin component (A) and curing agent component (B) is then introduced into the previously cleaned borehole by means of a known injection device. Subsequently, the component to be affixed is set in the mortar composition and adjusted. The reactive constituents of the curing agent component (B) react with the epoxy resins of the epoxy resin component (A) by polyaddition such that the epoxy resin composition cures under ambient conditions within a desired period of time, preferably within minutes or hours.

The epoxy resin component (A) and curing agent component (B) are preferably mixed in a ratio that results in a balanced stoichiometry according to the EEW and AHEW values.

The AHEW value (amine hydrogen equivalent weight, H equivalent) indicates the amount of the curing agent component containing 1 mol reactive H. The EEW (epoxide equivalent weight) value is usually specified by the manufacturers of the epoxy resin components used in each case or they are calculated using known methods. The EEW value indicates the amount in g of epoxy resin containing 1 mol of epoxy groups.

The AHEW was obtained experimentally by determining the glass transition temperature (Tg) of a mixture of epoxy resin (with known EEW) and amine component. In this case, the glass transition temperatures of epoxy resin/amine mixtures were determined with different ratios. The sample was cooled at a heating rate of −20 K/min from 21 to −70° C., heated in a first heating cycle to 250° C. (heating rate 10 K/min), then re-cooled to −70° C. (heating rate −20 K/min), and heated to 200° C. in the last step (20 K/min). The mixture having the highest glass transition temperature in the second heating cycle (“T_{g}2”) has the optimum ratio of epoxy resin and amine. The AHEW value can be calculated from the known EEW and the optimum epoxide resin/amine ratio.

### BRIEF DESCRIPTION OF THE FIGURES

FIG. 1 shows the creep behavior of examples 1 and 2 compared to the creep behavior of comparative example 1;

FIG. 2 shows the creep behavior of examples 3 and 4 compared to the creep behavior of comparative example 2.

The invention is explained in greater detail in the following with reference to a number of examples. All examples and drawings support the scope of the claims. However, the invention is not limited to the specific embodiments shown in the examples and drawings.

### EMBODIMENTS

Unless stated otherwise, all constituents of the compositions that are listed here are commercially available and were used in the usual commercial quality.

Unless stated otherwise, all % data given in the examples relate to the total weight of the composition described, as a calculation basis.

TABLE 1
List of the constituents used in the examples and references
(explanation of abbreviations) as well as their trade
names and sources of supply

| | | Chemical | |
|---|---|---|---|
| Function | Trade Name | specification | Manufacturer |
| Epoxide | Araldite ® | Bisphenol A-based | Huntsman Advanced |
| resin | GY 240 | epoxy resin | Materials, Germany |
| Epoxide | Araldite ® | Bisphenol F-based | Huntsman Advanced |
| resin | GY 282 | epoxy resin | Materials, Germany |
| Reactive | Araldite ® | 1,4-butanediol | Huntsman Advanced |
| diluent | DY-206 | diglycidyl | Materials, Germany |
| | | ether (BDDGE) | |
| Reactive | Araldite ® | Trimethyolpropane | Huntsman Advanced |
| diluent | DY-T-CH | triglycidyl ether | Materials, Germany |
| | | (TMPTGE) | |
| Adhesion | GLYMO | (3- | Evonik Resource |
| promoter | | Glycidyloxypropyl) | Efficiency, Germany |
| | | trimethoxysysilane | |
| Filler | Millisil ® | Quartz powder, | Quarzwerke, |
| | W12 | mean particle size | Germany |
| | | d₅₀ = 16 μm | |
| Cement | SupraCem | Portland cement | Schretter & |
| filler | 45 | | Cie GmbH |
| | | | & Co. KG, Austria |
| Thickener | CabOSil ® | Fumed silica | Cabot Corporation, |
| | TS 720 | | Germany |
| Amine | mXDA | m-xylylenediamines | MGC, Japan |
| Amine | Dytek ® A | 2-methylpentane- | Invista, The |
| | | 1,5-diamine | Netherlands |
| Amine | Vestamine ® | Isophorone diamine | Evonik Degussa, |
| | IPD | (IPDA) | Germany |
| Amine | 1,3-BAC | 1,3-bis | Itochu, Germany |
| | | (aminomethyl) | |
| | | cyclohexane | |
| Amine | Baxxodur ® | Methylcyclohexyl | BASF, Germany |
| | EC 210 | diamine (MCDA) | |
| Accel- | Phenolite ® | Phenolic | DIC Europe. |
| erator | TD 2131 | novolac resin | Germany |
| Tertiary | Ancamine ® | 2,4,6- | Air products, The |
| amine | K54 | tris(dimethyl- | Netherlands |
| | | aminomethyl) | |
| | | phenol | |
| Accel- | Calcium | Ca(NO₃)₂ 4H₂O | Sigma Aldrich, |
| erator | nitrate | | Germany |
| Solvent | Glycerol | 1,2,3-propanetriol | Merck, Germany |

To prepare the epoxy resin components (A) according to Table 2, the liquid components were premixed by hand using a wooden spatula. The fillers and thickeners were then added and initially premixed by hand. The mixture was then stirred in a dissolver (PC laboratory system, volume 1 L) at 3500 rpm for 8.5 minutes at a negative pressure of 80 mbar.

To prepare the curing agent components (B) according to Table 2, the amines were premixed and the accelerator or the accelerator mixture was dissolved in the amine mixture. The filler and thickener were then added and premixed by hand. The mixture was then stirred in a dissolver (PC laboratory system, volume 1 L) at 3500 rpm for 8.5 minutes at a negative pressure of 80 mbar.

The accelerator Ca (NO₃)₂ was used as a solution in glycerol (1,2,3-propanetriol). To prepare the calcium nitrate solution, 400.0 g calcium nitrate tetrahydrate was added to 100.0 g glycerol and stirred at 50° C. until completely dissolved (3 hours). The solution prepared in this way contained 80.0% calcium nitrate tetrahydrate.

To prepare the mortar compositions, the epoxy resin component (A) and the curing agent component (B) according to the examples in Table 2 were filled into hard cartridges in a mixing ratio of 3:1. The hard cartridges were provided with a static mixer (Quadro mixer) and ejected by means of a dispenser. The first five strokes of ejected mortar compositions were discarded in order to ensure the correct mixing quality before they are injected into the borehole.

In order to determine the creep behavior, continuous load tests were carried out at maximum temperature capacity based on the description in guideline ETAG 001 Part 5 (Guideline for European Technical Approval of Metal Plugs for Use in Concrete), replaced by EAD 330499-00-0601. For this purpose, the mortar compositions obtained by mixing the epoxy resin component (A) and the curing agent component (B) according to (Table 2) were installed in cleaned (2× compressed air at 6 bar, 2× brushed and 2× compressed air at 6 bar) 14 mm boreholes in steel-clad concrete cylinders (C20/25) with an insertion depth of 72 mm. After a 24-hour curing period, the tests were started and carried out for a minimum of 40 days. The tests were carried out at a temperature of 43° C.

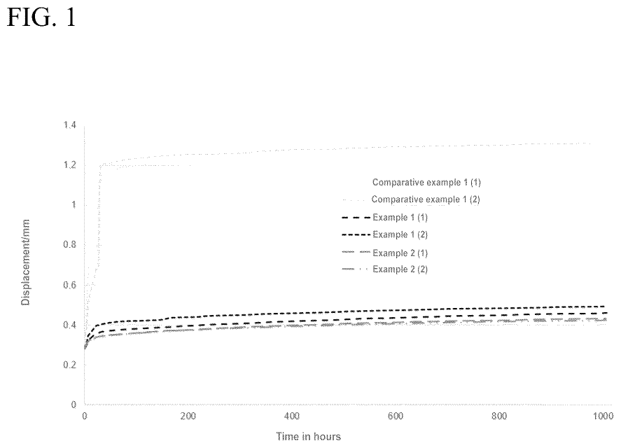

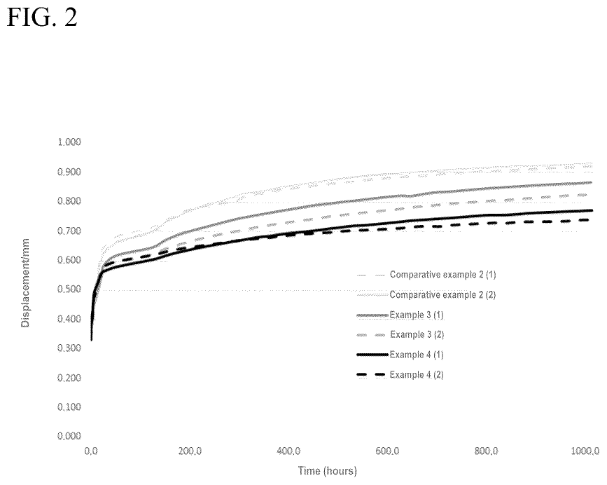

In the case of the continuous load tests from examples 1 and 2 and comparative example 1, a continuous load of 27.1 KN was applied, while a continuous load of 28.0 kN was used in the continuous load tests from example 3 and comparative example 2, and a continuous load of 29.8 KN was applied in example 4. At the beginning of the tests, measurements were recorded at a high frequency (10 measurements/min in the first hour), followed by 1 measurement per hour. The results are shown in FIGS. 1 to 2.

TABLE 2
Composition of the epoxy resin components (A) and the curing agent components (B) and the mortar composition
resulting therefrom according to examples 1 to 4 (use in accordance with the invention) and the mortar
composition according to comparative examples 1 and 2 (not according to the invention) [in wt. %]

| | | Comparative | | | Comparative | | |
|---|---|---|---|---|---|---|---|
| | | example 1 | Example 1 | Example 2 | example 2 | Example 3 | Example 4 |
| Epoxy | Araldite ® GY 240 | 39.0 | 34.2 | 30.0 | 26.3 | 25.2 | 22.1 |
| resin | Araldite ® GY 282 | 21.0 | 18.4 | 16.1 | 14.1 | 13.6 | 12.0 |
| component | Araldite ® DY-026 | 7.5 | 6.6 | 5.8 | 5.0 | 4.8 | 4.3 |
| A | Araldite ® DY-T-CH | 7.5 | 6.6 | 5.8 | 5.0 | 4.8 | 4.3 |
| | Millisil ® W12 | 22.3 | 31.6 | 39.6 | — | — | — |
| | Cab-o-Sil ® 720 | 2.7 | 2.7 | 2.7 | 1.7 | 1.5 | 1.3 |
| | GLYMO | — | — | — | 6.2 | 6.2 | 6.2 |
| | SupraCem 45 | — | — | — | 41.7 | 43.9 | 49.8 |
| | EEQ / g/eq | 211 | 240 | 274 | 289 | 300 | 337 |
| Curing | IPDA | — | — | — | — | — | 19.8 |
| agent | mXDA | 8.3 | 7.9 | 7.5 | 3.6 | 3.6 | — |
| component | 1,3-BAC | — | — | — | 24.1 | 24.1 | 19.8 |
| B | MCDA | — | — | — | 8.3 | 8.3 | — |
| | Dytek ® A | 33.5 | 31.9 | 30.3 | — | — | — |
| | Phenolite ® TD 2131 | 10.6 | 10.1 | 9.6 | — | — | — |
| | Millisil ® W12 | 43.2 | 40.7 | 38.2 | 53.9 | 51.8 | 48.6 |
| | Cab-o-Sil ® 720 | 4.4 | 4.4 | 4.4 | 2.1 | 2.2 | 4.3 |
| | Ca(NO₃)₂ (80% in glycerol) | — | — | — | 5.0 | 5.0 | 2.5 |
| | Ancamine ® K54 | 0.0 | 5.0 | 10.0 | 3.0 | 5.0 | 5.0 |
| | AHEQ / g/eq | 71 | 75 | 79 | 96 | 96 | 98 |

Examples 1 and 2 according to Table 2 differ from comparative example 1 only by virtue of the fact that Ancamine® K54 is present in different weight percentages. FIG. 1 shows the results of the continuous load tests for determining the creep behavior of the cured mortar compositions according to examples 1 and 2 compared to comparative example 1. FIG. 1 shows an improved creep behavior with a lower initial displacement following sustained loading and exposure to elevated temperatures for mortar compositions containing Ancamine® K54.

FIG. 3 shows the results of the continuous load tests for determining the creep behavior of the cured mortar compositions according to examples 3 and 4 compared to comparative example 2. The curing agent component (B) according to comparative example 2 contains Ancamine® K54 in a weight percentage of just 3 wt. % (not according to the invention). FIG. 2 shows an improved creep behavior with a lower initial displacement under sustained loading and at elevated temperatures for mortar compositions containing an increased weight percentage of Ancamine® K54. The cured mortar composition according to example 4 shows the best creep behavior with the lowest initial displacement, despite an increased continuous load of 29.8 KN, compared to example 3 and comparative example 2.

1. An epoxy resin composition for improving the creep behavior of a chemical anchor, the epoxy resin composition comprising:
at least one tertiary amine in a weight percentage of ≥1.0 wt. %, based on a total weight of the epoxy resin composition.

2. The epoxy resin composition according to claim 1, wherein the epoxy resin composition is a multi-component composition comprising at least one epoxy resin component containing at least one curable epoxy resin, and comprising at least one curing agent component containing at least one amine which is reactive to epoxide groups, wherein the at least one epoxy resin component and the at least one curing agent component are present separately from one another in a reaction-inhibiting manner.

3. The epoxy resin composition according to claim 2, wherein the at least one curing agent component comprises ≥5.0 wt. % of the at least one tertiary amine based on a total weight of the at least one curing agent component.

4. The epoxy resin composition according to claim 3, wherein a weight percentage of the at least one tertiary amine is 5.0 to 20.0 wt. % based on the total weight of the at least one curing agent component.

5. The epoxy resin composition according to claim 1, wherein the at least one tertiary amine comprises at least three tertiary amino groups and/or the tertiary amine has a 6-membered ring.

6. The epoxy resin composition according to claim 1, wherein the at least one tertiary amine is selected from the group consisting of 2,4,6-tris(di-C₁-C₆-alkylaminophenols) and 1,3,5-tris[3-(dimethylamino)propyl]hexahydro-1,3,5-triazine.

7. The epoxy resin composition according to claim 6, wherein the at least one tertiary amine is 2,4,6-tris(dimethylaminomethyl)phenol.

8. The epoxy resin composition according to claim 2, wherein the at least one curing agent component comprises at least one inorganic salt.

9. The epoxy resin composition according to claim 2, wherein the multi-component composition is present in cartridges or film pouches which comprise two or more separate chambers in which the at least one epoxy resin component and the at least one curing agent component are arranged separately from one another in a reaction-inhibiting manner.

10. The epoxy resin composition according to claim 2, wherein the at least one curable epoxy resin comprises a diglycidyl ether of bisphenol A or of bisphenol F or a mixture thereof.
